(19) United States
(12) Patent Application Publication
(10) Pub. No.: US 2026/0133070 A1
(43) Pub. Date: May 14, 2026

(54) MULTICODE MULTIPLEX SPECTRAL IMAGING

(71) Applicant: 10103560 Canada Ltd., CentrePort (CA)

(72) Inventors: David Allan Prystupa, Pinawa (CA); John Stephen Pacak, Winnipeg (CA)

(21) Appl. No.: 19/383,020

(22) Filed: Nov. 7, 2025

Related U.S. Application Data
(60) Provisional application No. 63/718,329, filed on Nov. 8, 2024.

(51) Int. Cl. G01J 3/28

(52) U.S. Cl. CPC G01J 3/28; G01J 2003/283

(57) ABSTRACT

A method is provided for measuring a set of input flux amplitudes which uses at least one flux detector and a hierarchal array of a plurality of logical encoder devices. The hierarchical array has a first level of encoders and at least one second level of encoders where one of said second level is a final level. Each encoder of the first level receives the amplitudes and outputs linear combinations of the amplitudes according to a first level sequence of encoders. The linear combinations of the first level define the input flux amplitude of one encoder of said second level and each encoder of the second level outputs linear combinations according to a second level sequence of encodings and each of the final level encoders devices is directed to a flux detector which measures the total amplitude and provides an output signal where an algorithm is applied to the output signal to calculate the input flux amplitudes.

### RELATED APPLICATIONS

This disclosure is related to High Efficiency Multiplexing; U.S. Pat. No. 10,585,044 issued Mar. 10, 2020 by the present inventors hereafter referred to as the HEMS patent. The disclosure of this HEMS patent is hereby incorporated herein by reference.

This disclosure is related to High Resolution Multiplexing System; U.S. Pat. No. 11,169,088 issued Nov. 9, 2021 by the present inventors hereafter referred to as the HRMS patent. The disclosure of this HRMS patent is hereby incorporated herein by reference.

This disclosure is related to Spatial Modulation Device; U.S. Pat. No. 11,137,270 issued Oct. 5, 2021 by the present inventors hereafter referred to as the SM patent. The disclosure of this SM patent is hereby incorporated herein by reference.

This disclosure is related to Multi-dimensional Spectroscopy of Macromolecules; U.S. Pat. No. 11,709,138 issued Jul. 25, 2023 by the present inventors hereafter referred to as the MDS patent. The disclosure of this MDS patent is hereby incorporated herein by reference.

This disclosure is related to Multiple Pass Imaging Spectroscopy; U.S. Pat. No. 8,345,254 issued Jan. 1, 2013 by the present inventors hereafter referred to as the MPIS patent. The disclosure of this MPIS patent is hereby incorporated herein by reference.

This disclosure is related to Amplified Multiplex Absorption Spectroscopy; U.S. Pat. No. 11,781,977 issued Oct. 10, 2023 by the present inventors hereafter referred to as the AMAS patent. The disclosure of this AMAS patent is hereby incorporated herein by reference.

This disclosure is related to High Resolution Multiplexing System; U.S. Pat. No. 11,169,088 issued Nov. 9, 2021 by the present inventors hereafter referred to as the HRMS patent. The disclosure of this HRMS patent is hereby incorporated herein by reference.

This invention relates generally to a multiplex spectral imaging system. The methods described herein may be used for measuring spectral properties of objects in up to three spatial dimensions.

### BACKGROUND INFORMATION

Hadamard imaging is known in the art wherein a two dimensional image is projected onto a two dimensional spatial modulator and modulated radiation is received by a single detector. Each pixel area corresponds to one element of a Hadamard sequence. The spatial modulator is cycled through a sequence of configurations corresponding to cyclic permutations of the Hadamard sequence and the pixel values are obtained by solving a system of linear equations, generally represented as a matrix to be inverted. The Hadamard method has four major drawbacks. Firstly, the Hadamard method uses on average only half of the incident photons. This drawback is resolved in the above cited HEMS patent by directing radiation incident at each location on the encoder to one of a plurality of detectors. Secondly, the Hadamard method is limited to image sizes where the number of pixels is 2ⁿ, where n is an integer. If the number of required pixels is 2ⁿ⁺¹, a Hadamard sequence of length 2ⁿ⁺¹ is are required, almost doubling the measurement time. This drawback is resolved in the above cited HEMS patent by using pseudo-random encoding sequences of arbitrary length so that the number of measurements directly scales with the natural size of the required dataset. However, the solution creates its own problems. Matrix inversion is straight forward for a Hadamard matrix, but direct matrix inversion becomes increasingly difficult as the dimension of a matrix based on pseudo-random sequences increases. In both cases numerical round off errors become more significant as the number of pixels increases. Thirdly, the computational effort increases with the number N of amplitudes encoded as at least N Log N for Hadamard and N² for random sequences making large values of N computationally expensive. Fourth, the dynamic range of the detector naturally limits the number of pixels that can be handled by the Hadamard method. This drawback is partially resolved in the above cited HEMS patent by spreading the required dynamic range over multiple detectors. However, increasing the number of detectors also increases the complexity of the encoder placing a practical limit on the number of detectors that can be used.

### SUMMARY OF THE INVENTION

According to the invention there is provided a method for measuring a set of input flux amplitudes comprising:
providing at least one flux detector arranged to provide an output signal responsive to flux applied thereto,
providing a hierarchal array of a plurality of logical encoder devices having a first level of first logical encoder devices and at least one second level of second logical encoder devices;
wherein one of said second level is a final level;
where each logical encoder device of the first level receives the set of input flux amplitudes on an input path and outputs linear combinations of said input flux amplitudes according to a first level sequence of encodings along at least one output path of the first level logical encoder;
arranging the logical encoders such that the linear combinations of flux amplitudes on each output path of the first level defines the input flux amplitude of one logical encoder of said second level;
where each logical encoder device of the second level receives the set of input flux amplitudes on the output path from one of the first level and outputs linear combinations of said input flux amplitudes according to a second level sequence of encodings along at least one output path of the second level logical encoder;
wherein said one or more output paths of each of the final level logical encoders is directed to a respective one of said at least one flux detector;
wherein said at least one flux detector measures the total amplitude
wherein each linear combination of flux amplitudes output along each output path does not include at least one input flux amplitude;
and wherein said one or more output paths of each of the final level logical encoder devices is directed to a respective one of said at least one flux detector;
and applying an algorithm to the output signal from said at least one flux detector to calculate the input flux amplitudes therefrom.

This method as defined below is preferably designed for use in a system where the encoding of the input signals is transmitted to a single output such as in the HADAMARD system cited herein. In this method, each logical encoder device of the first level receives the set of input flux amplitudes on an input path and outputs linear combinations of said input flux amplitudes according to a first level sequence of encodings along a single output path of the first level logical encoder; wherein each logical encoder device of the second level receives the set of input flux amplitudes on the output path from one of the first level and outputs linear combinations of said input flux amplitudes according to a second level sequence of encodings along a single output path of the second level logical encoder and wherein the single output path of each of the final level logical encoders is directed to a respective flux detector wherein each linear combination of flux amplitudes output along each output path does not include at least one input flux amplitude.

This method as defined below is preferably designed for use in a system where the encoding of the input signals is transmitted to at least two outputs such as in the HEMS system cited herein. In this method, said at least one flux detector comprises a plurality of flux detectors each arranged to provide an output signal responsive to flux applied thereto and wherein each logical encoder device of the first level receives the set of input flux amplitudes on an input path and outputs linear combinations of said input flux amplitudes according to a first level sequence of encodings along at least two output paths of the first level logical encoder; wherein each logical encoder device of the second level receives the set of input flux amplitudes on the output path from one of the first level and outputs linear combinations of said input flux amplitudes according to a second level sequence of encodings along at least at least two output paths and wherein the said at least two output paths of each of the final level logical encoders is directed to a respective one of the plurality of flux detectors wherein each linear combination of flux amplitudes output along each output path does not include at least one input flux amplitude.

The present arrangement as described herein may provide one or more of the following features:

A first objective of the present disclosure is to provide a multiplex spectral imaging method.

A second objective of the present disclosure is to improve the signal-to-noise ratio (SNR) of spectral imaging.

A third objective of the present disclosure is to provide a spectral imaging method with a reduced cost.

A fourth objective of the present disclosure is to provide a spectral imaging method with an increased number of voxels.

The arrangement herein is a multiplex method for measuring a set of N input flux amplitudes. Each input flux amplitude is associated with a unique interval of at least one flux property different from the other N−1 flux amplitudes. The flux amplitude property may for example be one of wavelength, time, phase, polarization, direction, spatial coordinate, or any combination thereof. It is understood that each property may correspond to a range or ranges of a property. For example, the property may be a range of wavelengths between a minimum wavelength and a maximum wavelength. For example, the property may be a range of diffraction angles (different directions) wherein the range of angles is continuous but the range of a different property wavelength is discontinuous (different orders). The input flux amplitudes are mapped onto one or more detectors by a hierarchal array of M logical encoder devices wherein M is an integer greater than one. The term logical encoder herein means a hardware device or part thereof that receives a set of input flux amplitudes on an input path and outputs linear combinations of said input flux amplitudes along one or more output paths wherein the set of flux amplitudes on each output path differs from the set of input flux amplitudes. The logical encoder further cycles through a sequence of configurations specified by a code sequence wherein for each different configuration the logical encoder outputs a different linear combination of input flux amplitudes along each output path. The term code or code sequence herein refers to a symbolic representation of physical encoder configurations. Each code is applied to a different one of a set of input amplitudes. For example a binary code may represent transmission with a ‘0’ and reflection with a ‘1’ for each physical region of a logical encoder. The sequence of logical encoder configurations is selected to provide information about at least one property of the input flux amplitudes. Preferably the code sequence is selected to optimize the precision of measured flux amplitudes by maximizing the signal-to-noise ratio (SNR), as described more fully in the above cited HEMS patent by the current inventors. In some embodiments the functions of a plurality of logical encoders may be combined on a single physical device. The hardware implementation of a logical encoder may for example be the arrangement described in the above cited SM patent. The logical encoders are arranged such that the linear combinations of flux amplitudes on each output path of a first level logical encoder is the input flux amplitude of a second level logical encoder.

The arrangement used herein can be used in the Hadamard arrangement described above where the output of each logical encoder when encoded by the sequence of encodings is output on a single path where the output is supplied to the input of a respective one of the second level of logical encoders. The hierarchy of the levels may include only two or may include more levels where one of the second levels is a final level and the output of the final level is applied to the detector so that the flux detector measures the total amplitude of the linear combinations of input flux amplitudes selected by the final level logical encoder and all prior level logical encoders and provides said output signal in response thereto.

The arrangement herein can also be used with advantage with the disclosure of the above cited HEMS patent. In that case, specifically each output path of the first level logical encoder is associated with a different second level logical encoder. For example, a hierarchal array in which a first level logical encoder has two output paths will have two different logical encoders on the second level, one for each output path. The hierarchal array of logical encoders may be expanded recursively until the last of the hierarchal levels is reached. Each output path of the final level logical encoder is directed to a flux detector, which measures the total amplitude of the linear combinations of input flux amplitudes selected by the final level logical encoder and all prior level logical encoders.

For example, each output path of a second level logical encoder may become the input path of the flux detector. For example, each output path of a second level logical encoder may become the input path of a third level logical encoder. For example, each output path of a third level logical encoder may become the input path of the flux detector. For example, each output path of a third level logical encoder may become the input path of a fourth level logical encoder. For example, each output path of a fourth level logical encoder may become the input path of the flux detector. For example, each output path of a fourth level logical encoder may become the input path of a fifth level logical encoder. For example, each output path of a fifth level logical encoder may become the input path of the flux detector.

In accordance with an important feature of the invention, each level of the hierarchal encoder array applies encoding to different subsets of the set of input flux amplitudes. The subsets are selected such that the intersection of two or more subset members at different hierarchal levels is one input flux amplitude. For example, a first hierarchal level encoder may encode rows of a two dimensional array of flux amplitudes and a second hierarchal level encoder may encode columns of said two dimensional array of flux amplitudes. The intersection of one row set element and one column set element corresponds to a single pixel of said two dimensional array of flux amplitudes. A set of N input flux amplitudes may be divided into a group of p subsets of N/p flux amplitudes {a1, a2, a3 . . . ap}. Note that if N is not divisible by p, N can be augmented with NULL flux amplitudes to satisfy divisibility and the physical encoder is arranged such that the NULL amplitudes are always directed to a NULL length path (absorbed). Further note that the subsets preferably have the same number of elements, but the general method described herein can be implemented using subsets with unequal numbers of elements, provided certain conditions are satisfied as described in more detail below. A first level encoder may apply a code within a sequence of codes of length p to the subsets {a1, a2, a3 . . . ap} wherein the amplitude of every element in each subset is directed to the same output path that is all of the elements of subset a1 are directed to a common first output path and all of the elements of subset a2 are directed to a common second output path which may or may not be the same as the first output path (dependent on the encoder code at positions a1 and a2). The code is comprised of a sequence of characters of length p wherein each different character specifies a different output path. For example the code may be binary wherein a 0 represents a first output path and a 1 represents a second output path so that a 0 in the a1 position specified that the elements of subset a1 are directed to a first output path and a 1 in the a1 position specifies that the elements of subset a1 are directed to a second output path. In general, each encoder is generates a sequence of coded configurations wherein each code directs a different linear combination of subset elements along each output path. A second group of q subsets may be formed wherein each subset element contains exactly one element of each subset {a1, a2, a3 . . . ap} to give subsets {b1, b2, b3 . . . bq}. That is subset b1 contains one element of subset a1, one element of subset a2, one element of subset a3 and so on to one element ap. A second level encoder may apply a code of length q to the subsets {b1, b2, b3 . . . bq} wherein the amplitude of every element in each subset is directed to the same output path. A third group of r subsets may be formed wherein each subset contains exactly one element of each subset {b1, b2, b3 . . . bq} to give subsets {c1, c2, c3 . . . cr}. A third level encoder may apply a code of length r to the subsets {c1, c2, c3 . . . cr} wherein the amplitude of every element in each subset is directed to the same output path. The process of dividing the input flux amplitudes may be repeated recursively for each level of the encoder hierarchy until the intersection one subset from each level taken in any combination is one input flux amplitude. For example the intersection of subsets a1, b3, and cr is one input flux amplitude in a three level hierarchy. Further, the subsets are selected such that all N input flux amplitudes are at the intersection of at least one combination of subsets. In embodiments that include over sampling, one or more individual input flux amplitudes may be represented at the intersection of a plurality of combinations of subsets. At each hierarchal level the encoder(s) are fabricated such that each subset corresponds with a region, or group of regions on the encoder surface with a common physical attribute that functions to direct input flux amplitudes in a pre-specified direction or state (output path). The subset regions may be contiguous or non-contiguous. For example in a contiguous arrangement the subset regions may be abutting pixels of an image. For example in a non-contiguous arrangement the subset regions may correspond to sample wells in an array of sample wells wherein regions between sample wells are not included in the subset regions. As described in the SM patent cited above, the change in direction may be caused by transmission, reflection (at varying angles), refraction or diffraction and a change in state may be phase or polarization.

In accordance with an important feature of the invention, in the algorithm by which the detector outputs are used to calculate the input flux amplitudes, for each logical encoder there is a corresponding decoding function performed by a control device wherein the decoding function is one of (i) solution of a set of linear equations; (ii) statistical analysis as described in the above cited HEMS patent; (iii) a neural network inference; (iv) a set of amplitudes interpolated from a larger set of amplitudes or extrapolated from a smaller set of amplitudes. The last option carries an implicit assumption that the amplitudes are continuous and slowly varying as a function of some amplitude label, for example position. The decoding function method applied at each hierarchal level may be different or the same. For example a four layer hierarchy of encoders may use a different decoding function at each level in any order. However, the computation is simpler if the same decoding function method is used for all layers because mathematical operations can be combined as outlined below. The decoding functions are applied in reverse order. That is the last encoding operation is decoded first and the first encoding operation is decoded last. The use of subsets effectively factors a large scale encoding (N large) into a series of smaller scale encodings.

In accordance with an important feature of the invention there is provided a source of flux to be measured wherein the amplitude of said flux varies with one or more independent variable selected from the set of time, wavelength, phase, polarization, direction of propagation, or point of origin. The flux may be particles such as photons, electrons, ions, neutrons, or any other particle type that carries energy. The flux may be a propagating electromagnetic field associated with the aforementioned particles.

In accordance with an important feature of the invention there is provided a means to collect flux, a first set of optical directing elements, and a first encoder wherein said first set of optical directing elements operates to direct said collected flux to different temporal or spatial locations of said first encoder dependent upon an independent variable of the flux. Preferably the set of optical directing elements operates to regulate the confine the flux incident on each temporal or spatial region of the first encoder to a small range of directions. This feature allows the propagation direction of encoded flux to be calculated.

In accordance with an important feature of the invention there is provided a hierarchal array of M logical encoder devices arranged with m levels that for each array configuration operates to map at least some of N input flux amplitudes onto each of D flux detectors along a path P wherein the number of hierarchy layers m is an integer greater than one and less than or equal to M, the number of flux detectors D is an integer greater than or equal to one and less than N, and the path P includes m encoders. For notation, each logical encoder device is uniquely specified as Eᵢ where i ranges from 1 to M. Each path P has an associated ordered list of integer coefficients eⱼ where j ranges from 1 to m and wherein the index j specifies the order flux is incident upon each logical encoder device. The coefficients eⱼ specify or point to selected values of i in the list of all logical encoder device Eᵢ. For example if m=3 and the path runs through logical encoder device {E₁, E₄, E₇}, then e₁=1, e₂=4, and e₃=7. For each encoder path P including encoders eⱼ where j ranges from 2 to m, at least some flux encoded by encoder eⱼ₋₁ is incident upon and encoded encoder eⱼ. Each encoder in the hierarchal array of encoder cycles through a sequence of different configurations determined by a code sequence that modulate incident flux differently. Some input flux amplitudes Aᵢ may follow paths that do not terminate at a detector (Hadamard case, for example) and consequently include fewer than m encoders. Consequently, the path P followed each input flux amplitude may change with each change in configuration: that is the logical encoder device labeled eⱼ and eⱼ₋₁ may change with each configuration change. Each encoder configuration operates to modulate the flux received at each temporal or spatial location differently in accordance with a modulation code to produce a modulated radiation flux along one or more modulated flux paths. The different modulation codes and associated encoder configuration are applied in a temporal sequence.

In accordance with an important feature of the invention each logical encoder Eᵢ (0<=i<M) has sᵢ spatial or temporal regions wherein sᵢ is greater than or equal to three and wherein for each encoder configuration at least two spatial or temporal encoder regions direct radiation flux incident on said regions into different paths. In some embodiments one path has zero length as flux is absorbed and the remaining paths direct flux in different directions. In some embodiments each path directs flux in a different direction.

In accordance with an important feature of the invention each logical encoder Eᵢ (0<=i<M) receives a set of input amplitudes; divides the input flux amplitudes into three or more subsets according to a code sequence of length Li where L is an integer greater than or equal to 3; and directs the flux amplitudes of at least one subset of flux amplitudes to an output path. Each code in the sequence corresponds to a different encoder configuration that directs a different subset of input amplitudes onto each output path. The code sequence and corresponding encoder configurations are chosen such that each of the N amplitudes to be measured is included in at least one output path for at least one encoder configuration and for each encoder configuration a different subset of input amplitudes is directed along each output path. Preferably the code sequences and associated encoder configurations are further chosen to optimize a merit function, such as for example signal-to-noise ratio (SNR) of a calculated result as described in greater detail in the above cited HEMS patent by the current inventors.

In accordance with an important feature of the invention the set of logical encoders Eᵢ (0<=i<M) configurations are permuted at N or more time steps and for each time step the output flux amplitudes are measured for each output path of the last logical encoder eₘ for each path P.

In accordance with an important feature of the invention the flux detector functions to measure than amplitude of flux on each output path P. The flux detector may include an optical collection system that operates to focus flux on an output path onto a measurement surface. The optical collection system may for example be a lens, mirror or combination of lenses and mirrors. The measurement surface may for example be the surface of a photodiode. The flux detector functions to generate an electrical or optical signal proportional to the amplitude of the flux. The generated signal may be amplitude or phase and is preferably, but not necessarily linearly proportional to the flux. The amplitude is taken to mean the number of flux particles per second in the case of detector that counts each particle. Alternately, the amplitude may be a property of a field, for example voltage. The flux detector may for example be a photodiode that produces a photocurrent proportional to the number of photons incident within a specified wavelength range. The flux detector may for example be a conductive surface that receives a flux or electrons or ions and produces an electric current proportional to the charge received from a flux of incident electrons or ions. The flux detector may for example be a scintillation detector that generates a signal proportional to the flux of neutral particles such as neutrons. The flux detector may for example be an interferometer that compares incident flux to a reference flux.

In accordance with an important feature of the invention there is provided a control device in communication with each logical encoder Ei (1<=i<=M) and in communication with each flux detector. The control device functions to control the state or configuration of each logical encoder at each time step, to receive and store in physical memory the detector amplitudes, to analyze the detector amplitudes to provide information about the incident flux amplitudes, and to communicate the incident flux amplitudes to a user. The analysis includes executing a decoding function on the encoded detector signals by one or any combination of (i) solution of a set of linear equations; (ii) statistical analysis as described in the above cited HEMS patent; (iii) a neural network inference; (iv) a set of amplitudes interpolated from a larger set of amplitudes or extrapolated from a smaller set of amplitudes. The control device may for example be a microprocessor with memory and communication ports. The control device may for example be a FPGA with associated memory and communication ports. The control device may for example be an analog circuit configured to perform analog computations. The control device may for example be an optical computing device. The control device may consist of any combination of the foregoing examples.

In accordance with an important optional feature of the invention the control device applies a first decoding function to a first set of amplitudes encoded A times to produce a set of P amplitudes encoded A−1 times, and to the set of amplitudes encoded A−1 times applies a fitting function to at least two of the P amplitudes to produce a set of P+p amplitudes, and subsequently applies a second decoding function to said set of P+p amplitudes, wherein P is a positive integer and p is a positive or negative integer. This feature may be used for example for compressive imaging wherein a sparse data set of N measured amplitudes is used to estimate an array of voxels composed of qN voxels, where q is a real number greater than 1, possibly 100 or more. This feature may be applied where input amplitudes from proximate voxel regions, as measured along at least one measurement parameter are correlated.

In accordance with an important optional feature of the invention the control device causes the encoders Ei (1<=i<=M) to cycle through N permutations of logical encoder configurations wherein the rate of change in configuration of a first encoder is an integer multiple of the rate of change in the configurations of a second encoder and wherein the integer multiple is proportional to the ratio of the code sequence lengths of said first and second encoders.

In accordance with an important optional feature of the invention one or more logical encoders includes a transducer that functions to convert input flux of a first type to output flux of a second type wherein the conversion is applied to a set of encoder regions. For example, the transducer may operate on a set of spatial encoder regions to convert an input photon flux into an output electron flux. The output electron flux may for example be temporally encoded by a following logical encoder.

In accordance with an important optional feature of the invention which can be used independently with any of the above or following features, there is provided a second optical directing system which operates to direct modulated flux output from a first encoder to the input of a second encoder wherein the relative spatial or temporal arrangement of input flux is preserved in the directing. That is the image or pattern of flux amplitudes incident on a first encoder is projected onto a second encoder by the second optical directing system with possible magnification. The second optical directing system may for example be a set of optical elements such as mirrors, prisms, and lenses placed between a first encoder and a second encoder.

In accordance with an important optional feature of the invention which can be used independently with any of the above or following features, there is provided a second optical directing system which operates to direct modulated flux output from a first encoder to the input of a second encoder wherein a phase delay is added between the first encoder and second encoder. The phase delay may be added for example by including between the first encoder and second encoder an optical medium with refractive index greater than one. The phase delay may for example be different for different electromagnetic radiation wavelengths. In some embodiments the refractive index may be changed by applying an electromagnetic field. The phase delay may be added for example by changing the optical path length between the first encoder and second encoder.

In accordance with an important optional feature of the invention which can be used independently with any of the above or following features, there is provided a second optical directing system which operates to direct modulated flux output from a first encoder to the input of a second encoder wherein the optical path length between the first encoder and second encoder is changed. This feature may be used for example to construct a variable resolution Fourier Transform spectrometer. For example, the first encoder may encode each output amplitude with a different optical path length and the second optical directing system adds or subtracts a constant optical path length from each output amplitude. In this example the first encoder may encode optical path lengths between 0 mm and 1 mm in steps of 0.001 mm for and output 1000 spatially separated flux amplitudes and the second optical directing system adds a constant optical path length of between −100 mm and +100 mm to each spatially separated flux amplitude in steps of 1 mm. The optical path length may be changed by translating one or more reflective surfaces, for example with a piezo-electric actuator. The optical path length may be changed by increasing or decreasing the number of reflections in a multi-reflection apparatus, for example by changing an angle of incidence or for example by relative translation of two reflective surfaces to change the gap between reflective surfaces or to change the offset between reference edges of reflective surfaces. The optical path length may be changed by directing flux along a selected one of a plurality of different optical paths wherein the different optical paths are defined by an array of reflective surfaces which are movable to intercept and alter the optical path or not intercept and not alter the optical path. For example, an array of reflective surfaces may include a line of mirrors spaced x mm apart generally along an optical axis wherein each mirror may be translated or rotated to either intercept the optical axis at a preset position and angle of incidence, hence changing the direction of the optical path, or not intercept and not alter the optical path. In this way, the optical path length of an interferometer arm may be changed in x mm increments. This feature may be used in combination with translation of a reflective surface with a piezo-electric actuator wherein the tuning range of the piezo-electric actuator is selected such that there is at least some overlap between the optical path lengths selected by said fixed mirrors. The overlap region may be used to precisely align adjacent optical path segments.

In accordance with an important optional feature of the invention which can be used independently with any of the above or following features, there is provided a second optical directing system which operates to direct modulated flux output from a first encoder to the input of a second encoder wherein the polarization of said flux amplitudes is changed between the first encoder and second encoder. The polarization may be changed for example with a polarization rotating prism. The polarization may be changed for example with a first logical prism that operates to separate input flux amplitudes into a first flux amplitude and a second flux amplitude polarized orthogonal to said first flux amplitude, a second logical prism that rotates the polarization of said second flux amplitude, and a third logical prism that combines said first flux amplitude and rotated second flux amplitude to produce an output flux amplitude. The logical prisms may be separate physical arrangements, or combined as one or two physical arrangements. This feature may be used for example as a polarization analyzer. This feature may be used for example to increase the efficiency of a following dispersive element such as a grating by causing all flux incident thereon to be polarized perpendicular to grating lines.

In accordance with an important optional feature of the invention which can be used independently with any of the above or following features, there is provided a wavelength optical directing system that collects spatially encoded flux amplitudes from a first encoder, disperses said flux amplitudes by wavelength, and directs said wavelength dispersed flux amplitudes to a second encoder. The wavelength directing device may for example be an arrangement of mirrors or lenses collecting flux amplitudes from the first encoder, collimating the collected flux amplitudes, directing the collimated flux amplitudes to a dispersive optical element such as a grating or prism, collecting with mirrors or lenses dispersed flux amplitudes, and focusing said dispersed flux amplitudes by wavelength onto a second encoder wherein the focusing operates to direct flux amplitudes with different wavelength to different locations on the second encoder. The wavelength directing device may for example be a dispersive medium such as an optical fiber that receives spatially and temporally modulated flux amplitudes from a first encoder, and transmits said flux amplitudes to a second encoder with a wavelength dependent time delay.

In accordance with an important optional feature of the invention which can be used independently with any of the above or following features, there is provided a second optical directing system which operates to switch between directing modulated flux output from a first encoder to the input of a second encoder wherein the relative spatial or temporal arrangement of input flux is preserved in the directing to directing modulated flux from a first encoder to a detector. In the case modulated flux is directed to a detector, the detector further communicates for a sequence of first encoded configurations measured amplitudes to a control device and the control device performs the step of calculating input amplitudes from the measured encoded amplitudes and the step of selecting at least one encoder configuration from a set of encoder configurations based at least in part on the calculated input amplitudes. This feature may be used for example to select a spatial region of interest from a large spatial area scan, and based on the input amplitudes from the large spatial area measurement select a smaller spatial sub-region for a subsequent measurement by altering at least one property of the encoder. The encoder property may for example be the size of encoder features. The encoder property may for example be a mask that selects an area of interest and sets to zero outputs from non-selected areas. The selected encoder configuration may be selected by dynamically altering one or more encoders or by replacing one or more encoders with other encoders having the selected property(s). That is each of the encoder devices can comprise a single dedicated encoder device or at least two of the logical encoder devices is formed by a part of a common encoder device.

In an important embodiment that may be used in combination with any of the preceding or following embodiments, the product of code sequence lengths LU (1<=i<=M) is equal to N.

$$N = {L}_{1} * … {L}_{M} \qquad ( 1 )$$

Put another way, the code sequence lengths are factors of the number of input amplitudes. For example, if there are three encoders (M=3) and the total number of input amplitudes is 27, then the length of code sequence for each encoder is 3. The computational effort to decode measurements scales as the square of each sequence length so in the example given three codes of length 3 require 27 units of computing whereas a single code of length 27 requires 729 units of computing. Hence the factoring provided by the invention significantly reduces the computational effort required to decode a multiplex data set.

In an important embodiment that may be used in combination with any of the preceding or following embodiments, each logical encoder Eᵢ (1<=i<=M) in a hierarchal sequence of encoders has a single output path and m=M. In this case the logical encoders Eᵢ may be indexed in the order encountered by an input flux. The input of the first logical encoder with index E₁ is the set of radiation amplitudes to be measured and the input of each successive logical encoder is the output of the prior logical encoder. The output amplitude of the final logical encoder is measured for at least N different configurations of the logical encoders in the stack and the measured amplitudes are analyzed to provide information about the input amplitudes. As described in the above cited HEMS patent by the current inventors, measurements for more than N different or even redundant measurements, improve the signal-to-noise ratio over N measurements. In this embodiment, the logical encoders are equivalent to a stack of filters which may be implemented as a stack of physical devices. Alternately this embodiment may be implemented with a single physical device such as for example a micro-mirror array. For example, the amplitudes to be measured may be amplitudes of a two dimensional image projected onto a micro-mirror array. The image is represented as a two dimensional matrix A of amplitudes wherein each row of the matrix represents are row of the image and each column of the matrix represents a column of the image. A first encoding function E₁ is applied to the amplitude matrix A to give a set of first amplitudes Y₁.

$${E}_{1} A = {Y}_{1} \qquad ( 2 )$$

A second encoding function E₂ is applied to the output of the first encoding function to give a second set of amplitudes Y₂ which is measured. Hence,

$${E}_{2} {E}_{1} A = {E}_{2} {Y}_{1} = {Y}_{2} \qquad ( 3 )$$

Equation 3 may be solved stepwise by multiplying with the inverse of E₂ to recover Y₁ and then solving equation 1 for A. Alternately the inverse of E₂E₁ may be calculated to give

$$A = {( {E}_{2} {E}_{1} )}^{- 1} {Y}_{2} \qquad ( 4 )$$

Here (E₂E₁)⁻¹ is the decoding function applied to an array of detector measured values Y₂ in the control device.

Here two matrix operations are applied to measured amplitudes Y₂ in the control device to recover the input flux amplitudes. Physically the encoding applied to the micro-mirror array by the control device is the product of E₂E₁.

In an important embodiment that may be used in combination with any of the preceding or following embodiments, each logical encoder Eᵢ (1<=i<=M) in a hierarchal array of logical encoders has a plurality pᵢ of output paths wherein each path P from a flux amplitude input Aᵢ to a detector is comprised of m encoder output paths, one path being selected from each level of the hierarchal encoder array for each configuration of the encoder array. The number of flux detectors is the number of path permutations, hence the product of m values of pᵢ. For example if all pᵢ equal 2, then the number of flux detector doubles for each level of the encoder hierarchy. Since the minimum values of m is m=2, the minimum number of detectors D for this embodiment is 4 and the minimum number of detectors for m=3 is 8. Note that the case m=1 corresponds to the system described in the above referenced HEMS patent by the current inventors. The decoding function for this embodiment is obtained by repeated application of the method described in the above cited HEMS patent wherein the last encoding is decoded first and the first encoding is decoded last. For example, a two level system with four detectors is described in matrix form as follows:

$${Z}_{1} A = {Y}_{1} \qquad ( 5 )$$

Where Z₁ has the same meaning as the Z matrix in the HEMS patent. Briefly, Z1 is a cpN×N matrix where c is a repeat measurement factor greater than or equal to one, p is the number of output paths for the encoder, and N is the number of input flux amplitudes. The Z₁ matrix is conveniently, although not necessarily, partitioned into N×N sections, one section for each detector repeated c times. The rows of Z₁ in each section give the mapping of input flux amplitudes to output flux amplitudes in the corresponding row of the propagation vector Y₁. That is these would be measured amplitudes in a HEMS system, but are instead propagated to a second level of encoding. Similarly application of a second level of encoding gives

$${Z}_{2} {Z}_{1} A = {Z}_{2} {Y}_{1} = {Y}_{2} \qquad ( 5 )$$

where Z₂ likewise describes the mapping from the propagation vector amplitudes Y₁ to measured detector amplitudes Y₂. Taking a least squares solution to the last encoding we obtain

$$A = {[ {( {Z}_{2} {Z}_{1} )}^{T} {Z}_{2} {Z}_{1} ]}^{- 1} {( {Z}_{2} {Z}_{1} )}^{T} {Y}_{2} \qquad ( 6 )$$

This decoding function requires that the dimensions of Z₁ and Z₂ are selected such that the matrix multiplication is defined and further that [(Z₂Z₁)^{T}Z₂Z₁] is nonsingular.

The encoding operator Z₁ is applied to columns of the amplitude array A. If the following encoding operator Z₂ is applied to row, for example encoding input flux amplitudes in a XY plane, the output array Y₁ is replaced by its transpose (Z₁A)^{T} giving the solution

$$A = {( {{Z}_{1}}^{T} {Z}_{1} )}^{- 1} {{{Z}_{1}}^{T} [ {( {{Z}_{2}}^{T} {Z}_{2} )}^{- 1} {{Z}_{2}}^{T} {Y}_{2} ]}^{T} \qquad ( 7 )$$

In an important embodiment that may be used in combination with any of the preceding or following embodiments, an arrangement to measure N flux amplitudes distributed at even intervals along a line comprises a first optical directing system, a first encoder and a second encoder, n second optical directing systems, m flux detectors and a control device wherein n is an integer greater than one and m is an integer greater than one. The first encoder receives input flux amplitudes and outputs a sequence of encoded flux amplitudes along n first output paths in response to signals from the control device. A second optical directing system on each first output path directs flux amplitudes to a distinct region of the second encoder wherein the n distinct regions do not intersect. The second encoder receives n sets of encoded flux amplitudes and outputs a sequence of double encoded flux amplitudes along m second paths in response to signals from the control device. The amplitude along each second path is measured with a detector and the control device analyzes the sequence of measured amplitudes to calculate the input flux amplitudes. In this embodiment the length of the code sequence for the second encoder is increased by a factor of n over the length required to encode a single input path. This embodiment may be used for example to measure a static interference pattern with path difference varying (preferably linearly) along a measurement surface with applications to high resolution spectroscopy and holography.

In an important embodiment that may be used in combination with any of the preceding or following embodiments, an arrangement to measure N flux amplitudes distributed at even intervals along a line comprises a first optical directing system, a first encoder and two second encoders, two second optical directing systems, four flux detectors and a control device. The first optical directing system maps the input flux amplitudes onto a region of the first encoder one code sequence long. The flux amplitudes may for example define an interferogram wherein each position along the line corresponds to a different optical path difference between two interfering beams of polychromatic radiation.

In an important embodiment that may be used in combination with any of the preceding or following embodiments, an arrangement to measure N flux amplitudes distributed on a three dimensional surface comprises an optical pulse generation means, a first optical directing system, a first spatial encoder, two second spatial encoders, two second optical directing systems, four flux detectors with associated temporal encoder, and a control device. The optical pulse generation means generates a short duration (typically fs) pulse of probe radiation which interacts with a three dimensional sample material to generate interaction radiation which is collected by the first directing means. The following three spatial encoders encode two spatial dimensions and wavelength and the flux amplitudes received by the detectors are further temporally encoded. The temporal encoding is decoded by the control means to give the time of flight associated with spatially and wavelength encoded signal. Differences in time of flight may be converted to a distance between a sample point and the first directing means by multiplying by c, the speed of light. The control means then decodes the remaining two spatial dimensions and wavelength to yield amplitudes in three spatial dimensions and wavelength.

### BRIEF DESCRIPTION OF THE DRAWINGS

FIG. 1 is a schematic illustration of a first embodiment of the invention where the logical encoders are of the type described generally in the above cited HEMS patent where each encoder directs the signals after encoding with the different configurations along two or more paths so that the number of encoders in the second and subsequent levels is increased.

FIGS. 2A, 2B, and 2C show an encoding scheme for encoding two dimensional information with a single encoding step.

FIGS. 3A, 3B, and 3C show an encoding scheme to encode a long linear sequence of flux amplitudes.

FIG. 4 is a schematic illustration of a second embodiment of the invention where two logical encoders of the second level are part of the same second level physical encoder and two logical encoders of the third level are part of the same third level physical encoder so that the number of encoders in the second and subsequent levels is reduced and the number final flux detectors is thus significantly reduced to avoid use of multiple elements of this expensive component.

FIG. 5 is a schematic illustration of a third embodiment of the invention where the encoders provide an output signal only on one output line using for example the Hadamard encoding system thus simplifying the number of encoders and detectors.

FIG. 6 is a schematic illustration of a further embodiment of the invention based on FIG. 4 where an alternate operation of the system allows a low resolution scan of flux amplitudes for one encoded property.

### DETAILED DESCRIPTION

Embodiments of the present disclosure are described in detail with reference to the accompanying drawings. Detailed descriptions of constructions or processes known in the art may be omitted to avoid obscuring the subject matter of the present disclosure. Further in the following description of the present disclosure, various specific definitions found in the following description are provided to give a general understanding of the present disclosure, and it is apparent to those skilled in the art that the present disclosure can be implemented without such definitions.

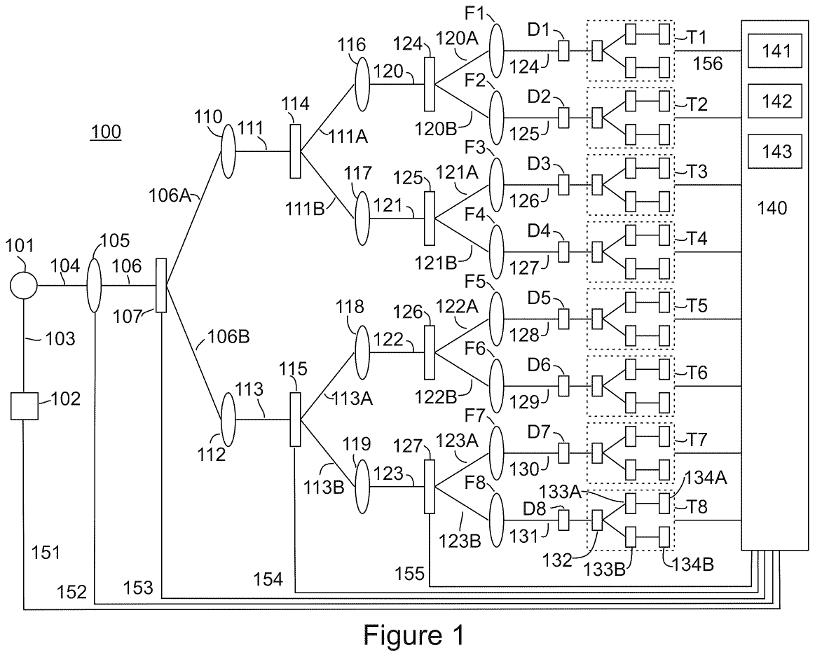

FIG. 1 shows an exemplary embodiment of the invention generally indicated at 100. The arrangement shown schematically at 100 is a spectral imaging system with temporal resolution. A source of flux indicated at 101 may be temporally modulated by an MDS modulator 102. The source of flux may be a two dimensional array of sample regions. The MDS modulator may for example be the Multi-Dimensional Spectroscopy arrangement in the above cited patent. Briefly, the MDS modulator generates a sequence of electromagnetic fields in a sample region that alter the state of sample molecules and hence their spectral response. As indicated at 151, MDS modulator may be in communication with a control device 140. Control device 140 may generate control signals that synchronize the timing of temporally modulated events generated by the MDS modulator. The source of flux 101 may for example be a sample material illuminated by a radiation source. The source of flux 101 may for example be the output beam of an optical amplification device as described in the above cited MPIS patent. The source of flux 101 may for example be the output beam of an optical amplification device as described in the above cited AMAS patent. Input flux amplitudes 104 are collected by optical elements 105 which direct an image 106 of the flux source, for example a two dimensional array of sample regions to first level spatial encoder 107. As indicated at 152, optical elements 105 may be in communication with control device 140. Control device may produce signals which cause optical elements 105 to change configuration. The configuration change may for example be rotating a polarization analyzer.

Spatial encoder 107 is in communication with and controlled by control device 140 as shown at 153. Control device 140 produces signals that specify the configuration of spatial encoder 107. Spatial encoder may for example be the arrangement described in the above cited SM patent. Spatial encoder 107 may spatially encode flux amplitudes varying in a first direction for example the X direction. Spatial encoder outputs two X-encoded streams 106A and 106B which are collected and directed by second optical directing system 110 and 112, respectively. Second optical directing system 110 and 112 may image the outputs 106A and 106B of spatial encoder 107 along paths 111 and 113, respectively, onto second level spatial encoders 114 and 115, respectively.

Second level spatial encoders 114 and 115 may encode in a second direction orthogonal to the first direction, for example direction Y. Second level spatial encoders 114 and 115 may for example be the arrangement described in the above cited SM patent. As indicated at 154, second level spatial encoders are in communication with and controlled by control device 140. Control device 140 generates signals which cause spatial encoders 114 and 115 to change configuration. Hence output beams 111A and 111B from Y encoder 114 are XY encoded and collected by wavelength optical directing system 116 and 117, respectively. Wavelength directing devices 116 and 117 collimate their respective input fluxes, direct the collimated flux onto a dispersive element such as a grating or prism, and output wavelength dispersed beams 120 and 121 toward encoders 124 and 125, respectively. Likewise output beams 113A and 113B from Y encoder 115 are XY encoded. Likewise wavelength directing devices 118 and 119 collimate their respective input fluxes, direct the collimated flux onto a dispersive element such as a grating or prism, and output wavelength dispersed beams 122 and 123 toward encoders 126 and 127, respectively.

Third level encoder 124 receives XY encoded and wavelength dispersed flux 120 and applies a wavelength encoding to the flux producing two XY and wavelength encoded output fluxes shown at 120A and 120B. Third level encoder may for example be the arrangement described in the above cited SM patent. As indicated at 155, third level spatial encoders are in communication with and controlled by control device 140. Control device 140 generates signals which cause wavelength encoder 124 to change configuration.

Third level encoder 125 receives XY encoded and wavelength dispersed flux 121 and applies a wavelength encoding to the flux producing two XY wavelength encoded output fluxes shown at 121A and 121B. Third level encoder may for example be the arrangement described in the above cited SM patent. As indicated at 155, third level spatial encoders are in communication with and controlled by control device 140. Control device 140 generates signals which causes wavelength encoder 125 to change configuration.

Third level encoder 126 receives XY encoded and wavelength dispersed flux 122 and applies a wavelength encoding to the flux producing two XY wavelength encoded output fluxes shown at 122A and 122B. Third level encoder may for example be the arrangement described in the above cited SM patent. As indicated at 155, third level spatial encoders are in communication with and controlled by control device 140. Control device 140 generates signals which causes wavelength encoder 125 to change configuration.

Third level encoder 127 receives XY encoded and wavelength dispersed flux 123 and applies a wavelength encoding to the flux producing two XY wavelength encoded output fluxes shown at 123A and 123B. Third level encoder may for example be the arrangement described in the above cited SM patent. As indicated at 155, third level spatial encoders are in communication with and controlled by control device 140. Control device 140 generates signals which causes wavelength encoder 127 to change configuration.

Triple encoded flux 120A is focused by optical elements F1 onto flux detector D1 as shown at 124. Triple encoded flux 120B is focused by optical elements F2 onto flux detector D2 as shown at 125. Triple encoded flux 121A is focused by optical elements F3 onto flux detector D3 as shown at 126. Triple encoded flux 121B is focused by optical elements F4 onto flux detector D4 as shown at 127. Triple encoded flux 122A is focused by optical elements F5 onto flux detector D5 as shown at 128. Triple encoded flux 122B is focused by optical elements F6 onto flux detector D6 as shown at 129. Triple encoded flux 123A is focused by optical elements F7 onto flux detector D7 as shown at 130. Triple encoded flux 123B is focused by optical elements F8 onto flux detector D8 as shown at 131. Optical elements F1, F2, F3, F4, F5, F6, F7 and F8 may for example be an arrangement of mirrors and lenses.

Each of the detector amplitudes at detectors D1, D2, D3, D4, D5, D6, D7 and D8 may be transferred to a temporal encoding module T1, T2, T3, T4, T5, T6, T7 and T8, respectively. As shown at 156, each temporal encoding module is in communication with control device 140. The temporal encoding module may for example be the arrangement described in the above cited HRMS patent by the current inventors. The temporal encoding module T8 for example includes a temporal encoder 132 that produces two output streams directed toward integrating devices 133A and 133B. At the end of an integration cycle, the integrated fluxes are output to measurement devices 134A and 134B which may for example be analog to digital conversion (ADC) devices. The digitized outputs are directed to control device 140.

Control device 140 hence receives 8 sequences of digitized signals corresponding to the amplitudes of 8 quadruple encoded input flux amplitudes: X, Y, wavelength, and time. Control device 140 includes a storage device 141 which provides both short and long term storage of the digitized signal sequences, a computation device 142 which executes an algorithm to decode the digitized signal sequences, and a communication device 143 which transmits stored data and the decoded amplitudes to a user and receives user commands. Computation device 142 may for example be a microprocessor, a FPGA, or an analog computer. Control device 140 operates on the 8 input digitized signals to compute input amplitudes as a function of time according to method described above which include equations 6 and 7 and neural network inference.

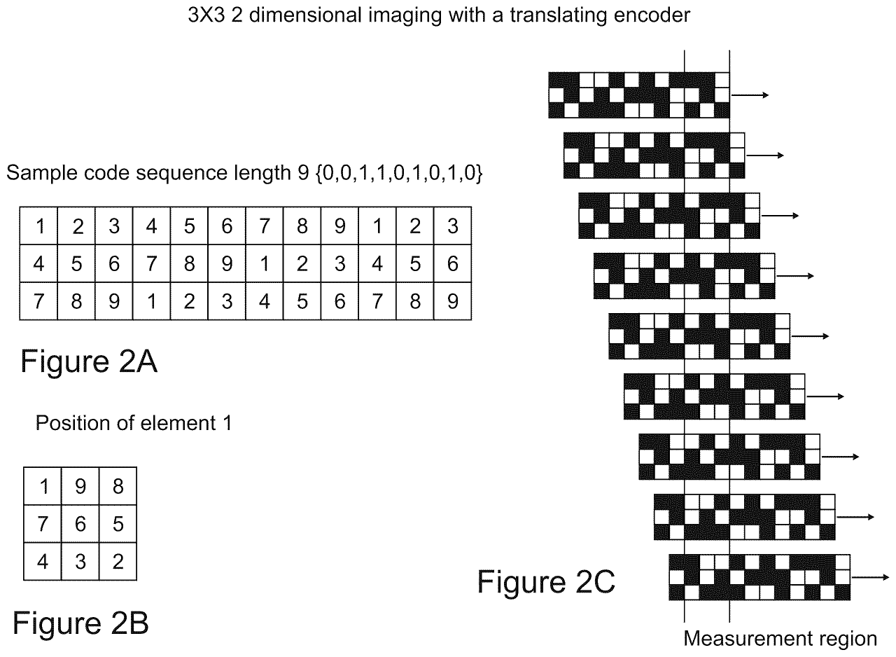

FIGS. 2A, 2B, and 2C show an encoding scheme for encoding two dimensional information with a single encoding step. FIG. 2A shows a linear code sequence of length 9 and a 3×12 two dimensional encoding scheme indicating where to locate each element of the code sequence on a physical encoding device. In the encoding scheme the first member of the sequence, 0 in this example is placed at each location a ‘1’ appears. FIG. 2B indicates the position of the first element in each of 9 configurations of the encoder. FIG. 2C shows an encoder according to the scheme shown in FIG. 2A translated through 9 positions which position each of the 9 configurations within the measurement zone indicated at the bottom.

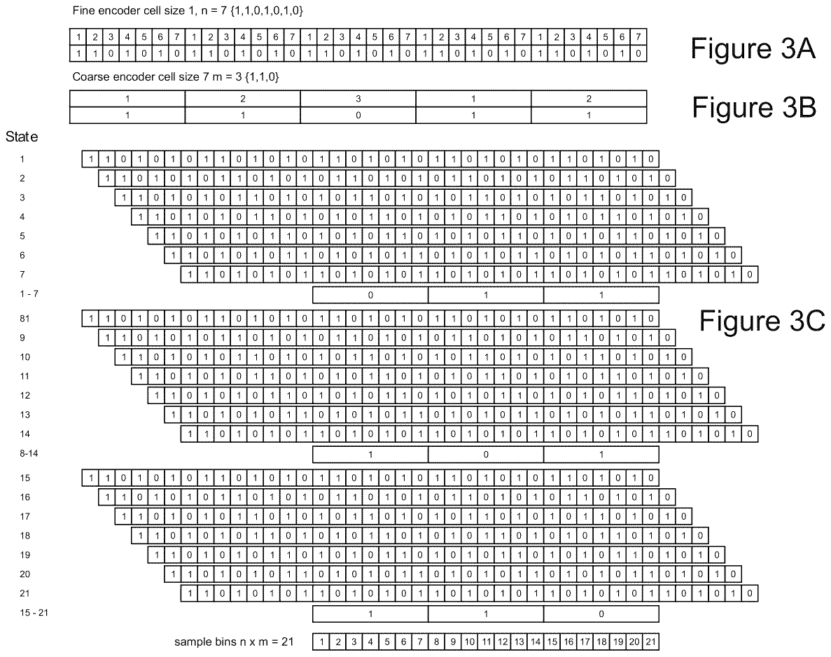

FIGS. 3A, 3B, and 3C show an encoding scheme to encode a long linear sequence of flux amplitudes. For illustration, the long sequence is represented as a sequence of length 21 factored into sub sets of 3 and 7 elements. The method shown can be applied to sequences of length in the millions to billions. FIG. 3A shows a first encoding sequence of length 7 that is repeated. The number in the top row indicates the ordinal number of the sequence to use and the bottom row gives the value to be used for a region of a physical encoder. A ‘0’ may for example represent transmission of incident flux along a first output path and a ‘1’ may for example represent reflection of incident flux along a second output path. FIG. 3B shows the scheme for a second encoder wherein the size of each encoding region is the size of a complete code sequence in the first encoder. The number in the top row indicates the ordinal number of the sequence to use and the bottom row gives the value to be used for a region of a physical encoder. FIG. 3C shows the manner in which the configurations of the two encoders are permuted within the measurement region to produce 21 different permutations. The input amplitudes may be computed using equation 6.

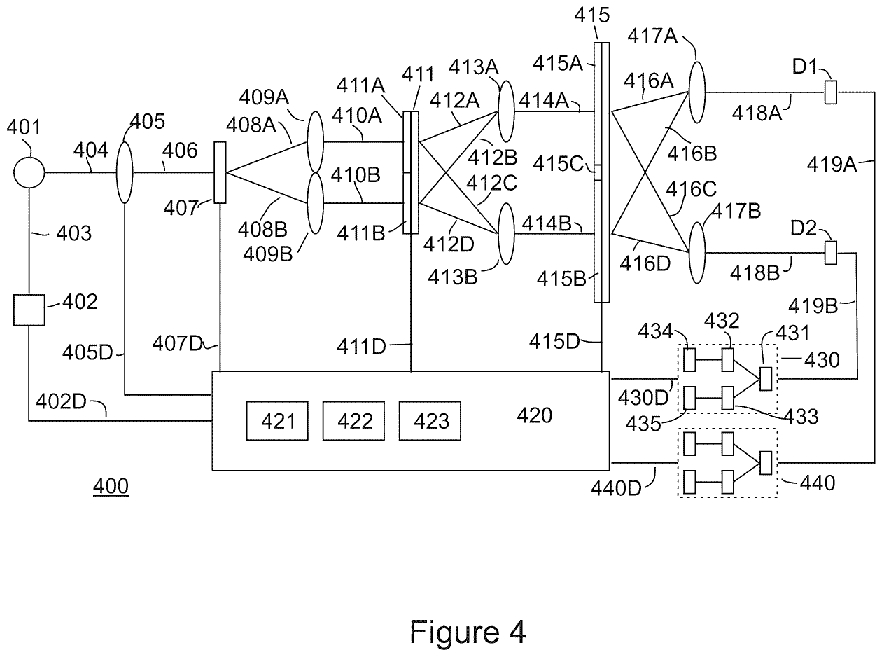

FIG. 4 shows an embodiment of the invention with four levels of encoding generally indicated at 400. The four levels of encoding may for example include two spatial dimensions, wavelength and time in that order as shown for illustrative purposes. The variables may be encoded in any order and also in combination in similar embodiments. A source of flux amplitudes to be measured is indicated at 401, which may for example be a sample region irradiated by a probe radiation to generate a flux of interaction radiation to be measured. The probe radiation may for example be from a quasi-monochromatic source such as a laser and the interaction radiation may be Raman scattered radiation. The probe radiation may for example be broadband radiation that is absorbed by sample material and the interaction radiation is transmitted or reflected radiation from the sample area. The interaction radiation may for example be emissions of the sample material such as fluorescence, thermal radiation, or radiation due to excitation by an external energy source (photons, electrons, neutrons, ions, etc.). The flux amplitudes may be temporally modulated by application of electromagnetic or acoustic perturbations generated by MDS device 402 linked with flux source as indicated at 403. MDS device may for example be the arrangement described in the above cited MDS. MDS device is in communication with and controlled by control device 420 as indicated at 402D. Briefly, control device 420 generates signals that control the direction and temporal dependence of electromagnetic and acoustic perturbations imposed on flux amplitude source 401.

Flux amplitudes 404 from source 401 are collected by optical directing system 405 and imaged along path 406 onto encoder 407. Optical directing system 405 may for example be an arrangement of optical elements such as mirrors, lenses, polarizers, prisms, phase plates, gratings, apertures, and the like that operate to image flux amplitudes onto encoder 407 with at least one independent parameter varying spatially at the encoder 407. Optical directing system 405 may for example be an arrangement of electric and magnetic elements for directing charged particles such as electrons or ions. Optical directing system may for example be an arrangement of crystals to diffract and direct neutrons. The term “optical element” herein refers to the elements commonly used for directing flux, whether the flux by photons, electrons, ions, or neutrons. The independent parameter may be for example a location of origin, wavelength, phase, or polarization. As indicated at 405D, optical directing system 405 may be in communication with control device 420. Control device 420 may for example generate control signals that cause optical directing system 405 to rotate a polarization analyzer. Control device 420 may for example generate control signals that cause optical directing system 405 to cause a change in optical path length causing a change the phase relation between flux amplitudes from source 401 and a reference flux (not shown). Control device 420 may for example generate control signals that cause optical directing system 405 to change the orientation of a dispersive element such as a grating or prism, thereby altering the spatial variation with wavelength at encoder 407. Control device 420 may for example generate control signals that cause optical directing system 405 to change the magnification of flux imaged onto encoder 407.

Encoder 407 applies a temporal sequence of codes to flux amplitudes 406 and outputs a plurality of output fluxes along different paths as shown at 408A and 408B. Encoder 407 may for example be a flexible loop encoder of the typed described in the above cited SM patent. Encoder 407 may for example be a static micro-mirror array. Two output paths are shown 408A and 408B for illustrative purposes. As described in more detail in the above cited HEMS patent, a plurality of output paths, each with different encoding, direct substantially all of the incident flux 407 onward along each path to a detector, thereby improving the signal-to-noise ratio of the measurements. The concepts illustrated herein with two paths may be applied to a larger number of output paths. As indicated at 407D, encoder 407 is in communication with and controlled by control device 420. Control device 420 may generate control signals that cause the encoder configuration to change wherein each different configuration combines different combinations of input flux amplitudes from different encoder locations into output paths in accordance with a code sequence. Control device 420 may receive feedback signals from encoder 407 indicative of the current encoder configuration.

Encoded flux amplitudes 408A and 408B are collected by second optical directing system 409A and 409B, respectively. Optical directing system 409A and 409B may be arrangements of optical elements as outlined above and are in communication with control device 420 as indicated at 409E. Flux amplitudes along path 408A are normally directed by directing system 409A along path 410A toward region 411A of encoder 411. Encoder 411 may for example be an embodiment of the encoder described in the above cited SM patent. Encoder 411 may for example be a micro-mirror array. Flux amplitudes along path 408B are normally directed by optical directing system 409B along path 410B toward region 411B of encoder 411.

The code sequence associated with encoder 411 is generally about twice as long as the code sequence required for encoding a single input path. Regions 411A and 411B of encoder 411 preferably abut, but do not intersect. The code sequence applied to encoder 411 is applied to the full region of flux to be encoded, including both regions 411A and 411B. Hence output path 412A of encoder 411 includes double encoded flux from input paths 410A and 410B. Hence output path 412B of encoder 411 includes double encoded flux from input paths 410A and 410B. Note that this arrangement applied to two parameters spanning N=pq elements factors a N×N matrix equation into separate p×p and 2q×2q matrix equations, which is more computationally efficient for N>5. As noted above, each encoder may include more than two output paths within the paradigm described in the above cited HEMS patent. As shown at 411D, encoder 411 is in communication with and controlled by control device 420. Control device may generate signals that operate to change the configuration of encoder 411 according to a code sequence of configurations. Each different configuration causes different combinations of flux amplitudes from different locations of encoder 411 to be directed along each output path. Control device 420 may receive feedback signals that indicate the current configuration of encoder 411.

Encoded flux amplitudes 412A and 412B are collected by second optical directing system 413A and 413B, respectively, which are in communication with control device 420 as indicated at 413E. Optical directing system 413A and 413B may be arrangements of optical elements as outlined above. Flux amplitudes along path 412A are normally directed by optical directing system 413A along path 414A toward region 415A of encoder 415. Encoder 415 may for example be an embodiment of the encoder described in the above cited SM patent. Encoder 415 may for example be a micro-mirror array. Flux amplitudes along path 412B are normally directed by optical directing system 413B along path 414B toward region 415B of encoder 415. The code sequence associated with encoder 415 is generally about twice as long as the code sequence required for encoding a single input path. Regions 415A and 415B of encoder 415 may be separated by region 415C which does not receive input flux. The region 415C may for example be used as a NULL reference. The code sequence applied to encoder 415 is applied to the full region of flux to be encoded, including regions 415A, 415B, and 415C. Hence output path 416A of encoder 415 includes triple encoded flux from input paths 414A and 414B. Hence output path 416B of encoder 415 includes double encoded flux from input paths 414A and 414B. As noted above, each encoder may include more than two output paths within the paradigm described in the above cited HEMS patent. As shown at 415D, encoder 415 is in communication with and controlled by control device 420. Control device may generate signals that operate to change the configuration of encoder 415 according to a code sequence of configurations. Each different configuration causes different combinations of flux amplitudes from different locations of encoder 415 to be directed along each output path. Control device 420 may receive feedback signals that indicate the current configuration of encoder 415. Triple encoded amplitude flux on path 416A is collected by second optical directing system 417A which focuses the flux onto the sensitive area of detector 419A along path 418A. Triple encoded amplitude flux on path 416B is collected by second optical directing system 417B which focuses the flux onto the sensitive area of detector 419B along path 418B. The second optical directing system 417A and 417B may for example be arrangements of optical elements as discussed above. Detectors 419A and 419B may for example be photodiodes or photomultipliers that operate, in combination with associated amplifier circuitry, to convert photon flux incident on the sensitive area into a voltage proportional to the integrated triple encoded flux. Detectors 419A and 419B may for example be conductive plates that operate, in combination with associated amplifier circuitry, to convert the electron or ion flux incident on the sensitive area into a voltage proportional to the integrated triple encoded flux. Detectors 419A and 419B may for example be scintillators that operate, in combination with associated amplifier circuitry, to convert the neutron flux incident on the sensitive area into a voltage proportional to the integrated triple encoded flux. As shown at 419C, voltage signals from detector 419A are routed to control device 420, optionally passing through fourth encoding stage 430. As shown at 419D, voltage signals from detector 419B are routed to control device 420, optionally passing through fourth encoding stage 440.

Fourth encoding stages 430 and 440 are identical. Each consists of temporal encoder 431, a plurality of integrators 432 and 433, and associated quantifiers 434 and 435, respectively. The quantifiers may be for example an analog to digital converter (ADC). The fourth encoding stage may for example be the temporal encoding arrangement described in the above cited HEMS patent. In another embodiment (not shown) the fourth encoding stage may be the temporal encoding arrangement described in the above cited HRMS patent. As indicated at 430D and 440D, the fourth encoding stage is in communication with and controlled by control device 420.

Control device 420 receives a temporal sequence of signals as either analog voltages or logical symbols representing values proportional to the integrated flux amplitudes and analyzes the signals to infer the input flux amplitudes, and communicates the input flux amplitudes to a user. Control device 420 includes a computation device 421 which may for example be a CPU, FPGA, or analog computation circuitry. Computation device 421 may coordinate control signals causing encoders to cycle through a plurality of permutations of configuration and correlating each configuration of encoders with measured flux amplitudes. Computation device 421 may for example apply equation 6 or equation 7 to the measured flux amplitudes to calculate input flux amplitudes. Computation device 421 may randomly select fewer than N permutations of encoder configurations and use neural networks to estimate the input flux amplitudes. Computation device 421 may select fewer than N permutations of encoder configurations based on correlation between input amplitudes and use statistical models to estimate the input flux amplitudes. Control device 420 includes data storage 422 consisting of both volatile and non-volatile data storage devices. Control device 420 includes communication device 423 which receives commands from an external user, transmits data and analysis results to a user, and manages signals to and from MDS device 402, first optical directing system 405, encoder devices 407, 411, 415, 430, and 440. Control device 420 may include an analog to digital conversion device 424 which operates to convert voltages received directly from detectors 418A and 418B into logic symbols for subsequent storage at storage device 422 and processing at computation device 421.

The text below gives a numerical worked example of the method of the invention applied to a two dimensional array wherein the encoding is applied separately to rows and columns here representing XY positions.

### Example of Two Dimensional Array

### Pixel Values:

| | | |
|---|---|---|
| 1 | 4 | 3 |
| 6 | 2 | 5 |
| 12 | 3 | 15 |

Apply code sequence 1,0,1 to rows in first encoder to give row encoded values:
4
11
27

Apply code sequence 1,0,1 to column in second encoder to give double encoded value 31 measured at the detector and repeat for each permutation of the sequence {1,1,0} and {0,1, 1} to give measured values 15 and 38, respectively.

| | |
|---|---|
| The matrix | 1, 0, 1 |
| has inverse | 1, 1, 0 |
| | 0, 1, 1 |
| | 0.5, 0.5. −0.5 |
| | −0.5, 0.5. 0.5 |
| | 0.5, −0.5. 0.5 |

The data vector {31, 15, 38} is multiplied by the inverse matrix to give {4, 11, 27}, the row encoded values.

The steps are repeated applying permuted code sequences {1,1,0} and {0,1,1} to the rows to give row encoded values {5,8,15} and {7,7,18}. Each set of row encoded values is column encoded as before to give detector measured values {20,13,23} and {25,14,25} which can be inverted with the matrix inverse to restore the row encoded values. The final step is to form data vectors corresponding to each row and apply the inverse matrix. Specifically the first row gives values {4, 5, 7} corresponding to the three encoder permutations and applying the inverse gives the row pixel values {1, 4, 3}. The remaining pixel rows are obtained by applying the inverse matrix to data vectors {11, 8, 7} and {27, 15,18}.

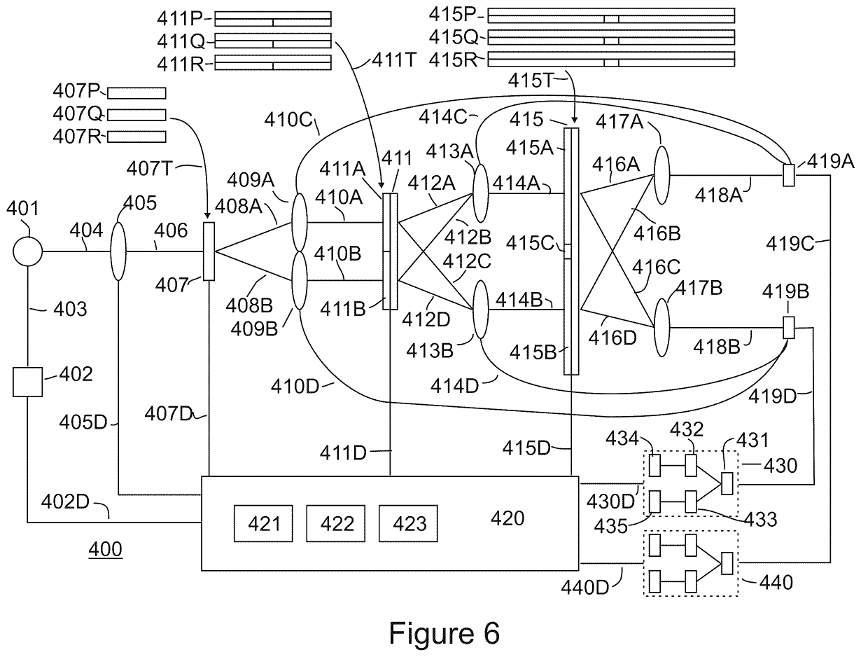

Turning now to FIG. 6, this shows the same arrangement as in FIG. 4 but an additional arrangement is provided which enables an initial analysis to be obtained for focusing more directly on selected areas the method of the present invention as described above in relation to FIG. 4. Thus in an initial operation, amplitudes along paths 408A and 408B may be directed instead along paths 410C and 410D to logical detector 419A and logical detector 419B, respectively. Preferably detectors 419A and 419B are used using switching devices to control the passage along the selected path. However additional dedicated detectors (not shown) may be used to receive the signals from paths 409C and 409D.

This alternate operation of the system allows a low resolution scan of flux amplitudes for one encoded property according to the above cited HEMS patent by the current inventors. Control device 420 may analyze said low resolution scan and select an alternative encoder from the set 407P, 407Q, and 407R with different code patterns to replace the function of encoder 407 as shown at 407T. Encoders 407P, 407Q, and 407R may be separate encoders, displaced regions of the same encoder, or different instances of a reconfigurable encoder such as a micro-mirror array. That is the alternate encoder is moved to location 407 or the flux amplitudes are routed to the selected encoder by transfer optics 405. Alternate encoders 407P, 407Q, and 407R may for example select a region of interest or alter the encoding resolution of the flux amplitudes.

Also in FIG. 6, alternately amplitudes along paths 412A and 412B may be directed instead along paths 414C and 414D to the detectors 419A and 419B, respectively which are in communication with control device 420. This alternate configuration allows a low-resolution scan of flux amplitudes for two encoded properties according to the current invention. Control device 420 may analyze said low-resolution two-dimensional scan and select an alternative encoder from the set 411P, 411Q, and 411R with different code patterns to replace the function of encoder 411 as shown at 411T. Encoders 411P, 411Q, and 411R may be separate encoders, displaced regions of the same encoder, or different instances of a reconfigurable encoder such as a micro-mirror array. That is the alternate encoder is moved to location 411 or the flux amplitudes are routed to the selected encoder by transfer optics 409A and 409B. Alternate encoders 411P, 411Q, and 411R may for example select a region of interest or alter the encoding resolution of the flux amplitudes. Control device 420 may additionally select from the set of alternate encoders 415P, 415Q, and 415R as indicated at 415T based at least in part on analysis of input flux amplitudes calculated from amplitude measurements at logical detectors 419A and 419B. Encoders 415P, 415Q, and 415R may be separate encoders, displaced regions of the same encoder, or different instances of a reconfigurable encoder such as a micro-mirror array. In this way, the analyzer system 400 may be optimally configured to measure a selected region of flux source 401 with a selected spatial or spectral resolution.

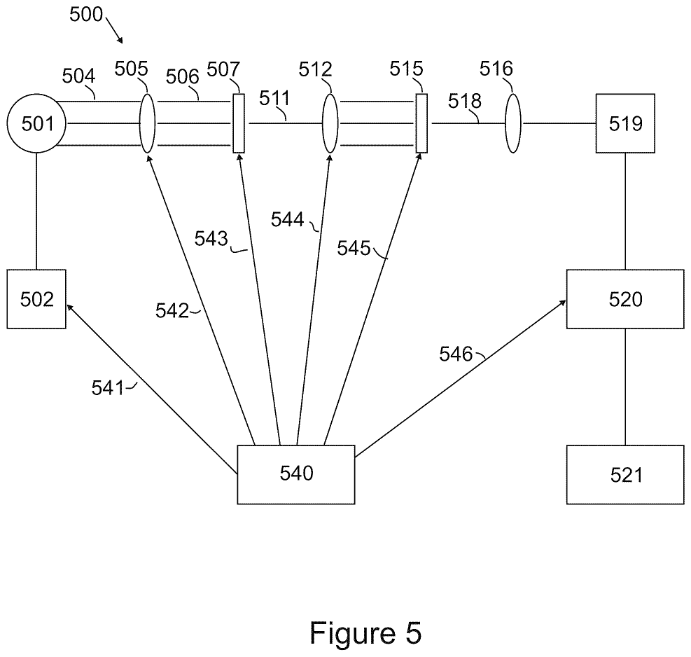

FIG. 5 shows an exemplary embodiment of the invention generally indicated at 500. The arrangement shown schematically at 500 is a spectral imaging system with temporal resolution. A source of flux indicated at 501 may be temporally modulated by an MDS modulator 502 in communication with control 541 as show at 541. The source of flux may be a two dimensional array of sample regions. Input flux amplitudes 504 are collected by optical elements 505 which direct an image 506 of the flux source, for example a two dimensional array of sample regions to first level spatial encoder 507. As indicated at 542, optical elements 505 may be in communication with control device 540.

Spatial encoder 507 is in communication with and controlled by control device 540 as indicated at 543. Control device 540 produces signals that specify the configuration of spatial encoder 507. Spatial encoder 507 may for example be the arrangement described in the above cited SM patent with a two dimensional array of code regions as illustrated in FIGS. 2A, 2B and 2C. Spatial encoder 507 may hence spatially encode a two dimensional array of flux amplitudes. Spatial encoder 507 outputs a single encoded stream 511 which is collected and directed by second optical directing system 512. Second optical directing system 512 may include optical elements which form a single collimated beam, disperse the collimated beam with a prism or grating, and image the output of spatial encoder 507 onto a second level spatial encoder 515. Control 540 may produce control signals as indicated at 544 which cause second optical directing system 512 to direct different ranges of wavelength onto second level spatial encoder 515, for example by rotating a dispersive element such as a grating. Second level spatial encoder 515 encodes in the direction of wavelength dispersion. Second level spatial encoder 515 may for example be the arrangement described in the above cited SM patent. Control device 540 generates signals which cause spatial encoder 515 to change configuration as indicated at 545. Hence output beam 518 from wavelength encoder 515 is XY encoded at encoder 507 and wavelength encoded at encoder 515. Optical directing device 516 collects the input flux 518 and focuses said flux onto flux detector 519. The flux detector 519 measures the total amplitude as a function of time for each MDS configuration all of the linear combinations of input flux amplitudes selected by the final level logical encoder, of all prior level logical encoders and provides an output signal in response thereto received by algorithm 520. Algorithm 520 takes as input timing signals from control 540 which indicate the state of each controlled device 502, 505, 507, 512, and 515 together with the output signal from the flux detector 519 to calculate the input flux amplitudes therefrom which are output as a series of values as indicated at 521. The algorithm can use any of the arrangements described above.

1. A method for measuring a set of input flux amplitudes comprising:
providing at least one flux detector arranged to provide an output signal responsive to flux applied thereto;
providing a hierarchal array of a plurality of logical encoder devices having a first level of first logical encoder devices and at least one second level of second logical encoder devices;
wherein one of said second level is a final level;
where each logical encoder device of the first level receives the set of input flux amplitudes on an input path and outputs linear combinations of said input flux amplitudes according to a first level sequence of encodings along at least one output path of the first level logical encoder devices;
arranging the logical encoders such that the linear combinations of flux amplitudes on each output path of the first level defines the input flux amplitude of one logical encoder devices of said second level;
where each logical encoder device of the second level receives the set of input flux amplitudes on the output path from one of the first level and outputs linear combinations of said input flux amplitudes according to a second level sequence of encodings along at least one output path of the second level logical encoder device;
wherein each linear combination of flux amplitudes output along each output path does not include at least one input flux amplitude;
and wherein said one or more output paths of each of the final level logical encoder devices is directed to a respective one of said at least one flux detector;
wherein said at least one flux detector measures the total amplitude of the linear combinations of input flux amplitudes selected by the final level logical encoder device and all prior level logical encoder devices and provides said output signal in response thereto;
and applying an algorithm to the output signal from said at least one flux detector to calculate the input flux amplitudes therefrom.

2. The method according to claim 1 wherein each logical encoder device of the first level receives the set of input flux amplitudes on an input path and outputs linear combinations of said input flux amplitudes according to a first level sequence of encodings along a single output path of the first level logical encoder device; wherein each logical encoder device of the second level receives the set of input flux amplitudes on the output path from one of the first level and outputs linear combinations of said input flux amplitudes according to a second level sequence of encodings along a single output path of the second level logical encoder device and wherein the single output path of each of the final level logical encoder devices is directed to a respective flux detector.

3. The method according to claim 1 wherein said at least one flux detector comprises a plurality of flux detectors each arranged to provide an output signal responsive to flux applied thereto and wherein each logical encoder device of the first level receives the set of input flux amplitudes on an input path and outputs linear combinations of said input flux amplitudes according to a first level sequence of encodings along at least two output paths of the first level logical encoder devices; wherein each logical encoder device of the second level receives the set of input flux amplitudes on the output path from one of the first level and outputs linear combinations of said input flux amplitudes according to a second level sequence of encodings along at least at least two output paths and wherein the said at least two output paths of each of the final level logical encoder devices is directed to a respective one of the plurality of flux detectors.

4. The method according to claim 1 wherein the algorithm comprises at least one of: solving a system of N equations in N unknowns; statistical inference using more than N measured values; neural network inference; and interpolation or extrapolation of partial solutions.

5. The method according to claim 1 wherein each logical encoder device in the hierarchal array of logical encoder devices cycles through a sequence of different configurations determined by a code sequence that modulate incident flux differently.

6. The method according to claim 1 wherein each encoder configuration operates to modulate the flux received at each temporal or spatial location differently in accordance with a modulation code to produce a modulated radiation flux along one or more modulated flux paths where the different modulation codes and associated encoder configuration are applied in a temporal sequence.

7. The method according to claim 1 wherein each level of the hierarchal array of logical encoder devices applies encoding to different subsets of the set of input flux amplitudes.

8. The method according to claim 7 wherein the subsets are selected such that the intersection of two or more subsets at different hierarchal levels is one input flux amplitude.

9. The method according to claim 1 wherein there is provided a source of flux to be measured wherein the amplitude of said flux varies with one or more independent variables selected from the set of time, wavelength, phase, polarization, direction of propagation, or point of origin.

10. The method according to claim 1 wherein the flux may be particles such as photons, electrons, ions, neutrons, or any other particle type that carries energy or the flux may be a propagating electromagnetic field associated with the aforementioned particles.

11. The method according to claim 1 wherein there is provided a collector to collect flux, a first directing element, and a first encoder device wherein said first directing element operates to direct said collected flux to different temporal or spatial locations of said first encoder device dependent upon an independent variable of the flux.

12. The method according to claim 11 wherein the first directing element operates to confine the flux incident on each temporal or spatial region of the first encoder device to a small range of directions thus allowing a propagation direction of encoded flux to be calculated.

13. The method according to claim 1 wherein the set of logical encoder device configurations are permuted at a plurality of time steps and for each time step the output flux amplitudes are measured for each output path of the last logical encoder device for each path.

14. The method according to claim 1 wherein there is provided a control device in communication with each logical encoder device and in communication with each flux detector where the control device functions to control the state or configuration of each logical encoder device at each time step, to receive and store in physical memory the detector amplitudes, to analyze the detector amplitudes to provide information about the incident flux amplitudes, and to communicate the incident flux amplitudes to a user.

15. The method according to claim 14 wherein the control device causes the encoder devices to cycle through permutations of logical encoder configurations wherein the rate of change in configuration of a first encoder is an integer multiple of the rate of change in the configurations of a second encoder device and wherein the integer multiple is proportional to the ratio of the code sequence lengths of said first and second encoder devices.

16. The method according to claim 1 used in compressive imaging wherein a sparse data set of n measured amplitudes is used to estimate an array of N>n voxels where input amplitudes from proximate voxel regions, as measured along at least one measurement parameter are correlated and said correlation is used to estimate the amplitude of at least one unmeasured voxel.

17. The method according to claim 1 wherein there is provided a second optical directing system which operates to direct modulated flux output from a first encoder to the input of a second encoder device wherein the relative spatial or temporal arrangement of input flux is preserved in the directing.

18. The method according to claim 1 wherein a phase delay is added between the first encoder device and second encoder device.

19. The method according to claim 1 wherein the polarization of said flux amplitudes is changed between the first encoder device and second encoder device.

20. The method according to claim 1 wherein flux amplitudes are dispersed by wavelength between the first encoder device and second encoder device.

21. The method according to claim 1 wherein each of the encoder devices can comprise a single dedicated encoder device or at least two of the logical encoder devices is formed by a part of a common encoder device.

22. The method according to claim 1 wherein the set of input flux amplitudes supplied to at least one of the logical encoder devices is interpolated from a larger set of amplitudes or extrapolated from a smaller set of amplitudes.
